(19) United States
(12) Patent Application Publication
(10) Pub. No.: US 2025/0390056 A1
(43) Pub. Date: Dec. 25, 2025

(54) IMAGE FORMING APPARATUS

(71) Applicant: CANON KABUSHIKI KAISHA, Tokyo (JP)

(72) Inventor: KO KATAHIRA, Kanagawa (JP)

(21) Appl. No.: 19/242,404

(22) Filed: Jun. 18, 2025

(30) Foreign Application Priority Data
Jun. 24, 2024 (JP) 2024-101546

(51) Int. Cl. G03G 21/16; G03G 15/20

(52) U.S. Cl. CPC G03G 21/1638; G03G 15/2035; G03G 15/2064; G03G 21/1647

(57) ABSTRACT

An image forming apparatus includes an apparatus main body, a door provided to be openable and closable with respect to the apparatus main body, a fixing unit that is configured to fix a toner image formed on a sheet to the sheet, and includes a pressing member, a pressed member configured to form a fixing nip portion with the pressing member, and a pressing force adjustment unit for reducing or releasing pressing force to be applied to the fixing nip portion, and an interlocking unit that is engageable with the pressing force adjustment unit, and configured to interlock opening and closing of the door with the pressing force adjustment unit, and by moving a first interlocking member, the first interlocking member moves the pressing force adjustment unit to a first position irrespective of a motion of a second interlocking member.

### BACKGROUND

### Field

The present disclosure relates to an image forming apparatus in which pressing force of a fixing device is released in tandem with opening/closing of a user access door during jam processing.

### Description of the Related Art

For example, an image forming apparatus such as a printer and a facsimile includes a fixing device that fixes a toner image formed on a sheet, by applying heat and pressure. The fixing device forms a nip portion by a pressing roller and a heating unit, and is configured to fix a toner image by applying heat and pressure to a sheet when the sheet passes through the nip portion.

Because pressing force to be applied at the nip portion of the fixing device is generally larger as compared with that of other conveyance rollers, in a case where a sheet jam occurs in the fixing device, it is more difficult to execute jam processing as compared with the other conveyance rollers. In a case where jam processing is executed in a state where large pressing force acts on the nip portion, there is a possibility that the following problems occur. More specifically, the sheet might be torn and it might become difficult to process a fragment of the sheet remaining in the fixing device, or a component of the fixing device might be broken when jam processing is executed with strong force.

In view of the foregoing, there has been proposed a technique of releasing pressing force of a fixing device in tandem with opening/closing of a door of an image forming apparatus when a user opens or closes the door to execute jam processing in the fixing device (refer to Japanese Patent Application Laid-Open No. 2006-48005). In the technique discussed in Japanese Patent Application Laid-Open No. 2006-48005, in tandem with an operation of opening the door, a pressure release lever of the fixing device rotates by being pressed by a pressure release shape portion provided on the door, and pressing force is released. Then, after the pressing force is released, the pressure release lever and the pressure release shape portion provided on the door are separated. This enables the release of pressing force for fixing during jam processing.

Nevertheless, in the image forming apparatus discussed in Japanese Patent Application Laid-Open No. 2006-48005, if the user touches the pressure release lever after the pressure at the fixing nip is released, there is concern that a state unintentionally shifts from a pressure release state to a pressed state.

### SUMMARY

In view of the foregoing, the present disclosure is directed to providing an image forming apparatus that prevents a state of a fixing nip from unintentionally shifting from a pressure release state to a pressed state after the pressure at the fixing nip is released.

According to some embodiments, an image forming apparatus includes an apparatus main body, a door provided to be openable and closable with respect to the apparatus main body, a fixing unit that is configured to fix a toner image formed on a sheet to the sheet, and includes a pressing member, a pressed member configured to form a fixing nip portion with the pressing member, and a pressing force adjustment unit for reducing or releasing pressing force to be applied to the fixing nip portion, and an interlocking unit that is engageable with the pressing force adjustment unit, and configured to interlock opening and closing of the door with the pressing force adjustment unit, wherein the door includes a door engagement portion configured to engage with the interlocking unit, wherein the interlocking unit includes a first interlocking member and a second interlocking member that are engaged with each other, wherein the fixing unit is switchable between a first state that is a state where predetermined pressing force is applied to the fixing nip portion, and is caused when the pressing force adjustment unit is at a first position, and a second state that is a state where pressing force to be applied to the fixing nip portion is reduced from the predetermined pressing force or released, and is caused when the pressing force adjustment unit is at a second position, wherein, during a process of opening the door from a closed state, the door engagement portion and the second interlocking member are engaged, the first interlocking member and the pressing force adjustment unit are engaged, and by the first interlocking member moving the pressing force adjustment unit, the pressing force adjustment unit moves from the first position to the second position, wherein, during a process of opening the door, when the pressing force adjustment unit is at the second position, the second interlocking member gets separated from the door engagement portion, and the second interlocking member is movable with respect to the first interlocking member when the pressing force adjustment unit is in the second state, and wherein, during a process of closing the door, by moving the first interlocking member, the first interlocking member moves the pressing force adjustment unit to the first position irrespective of a motion of the second interlocking member.

According to an aspect of the present disclosure, it is possible to provide an image forming apparatus that prevents a state of a fixing nip from unintentionally shifting from a pressure release state to a pressed state after the pressure at the fixing nip is released.

Further features of the present disclosure will become apparent from the following description of exemplary embodiments with reference to the attached drawings.

### BRIEF DESCRIPTION OF THE DRAWINGS

FIG. 1 is a schematic diagram of an image forming apparatus according to a first exemplary embodiment.

FIG. 2 is a schematic diagram of a fixing device according to the first exemplary embodiment.

FIG. 3 is a sectional view illustrating a configuration of a heating unit according to the first exemplary embodiment.

FIG. 4 is a schematic diagram illustrating a pressed state and a pressure release state of the fixing device according to the first exemplary embodiment.

FIGS. 5A and 5B are perspective views of a pressure release mechanism of the fixing device according to the first exemplary embodiment.

FIG. 6 is a diagram illustrating a pressure release cam according to the first exemplary embodiment.

FIG. 7 is a diagram illustrating a pressure release arm according to the first exemplary embodiment.

FIG. 8 is a diagram illustrating a fixing left cover according to the first exemplary embodiment.

FIG. 9 is a diagram illustrating a fixing interlocking lever according to the first exemplary embodiment.

FIG. 10 is a diagram illustrating a rear door interlocking lever according to the first exemplary embodiment.

FIG. 11 is a diagram illustrating a configuration of an interlocking member according to the first exemplary embodiment.

FIG. 12 is a diagram illustrating a configuration of a rear door according to the first exemplary embodiment.

FIGS. 13A and 13B are diagrams illustrating a latch according to the first exemplary embodiment.

FIG. 14 is a diagram illustrating a latch cover according to the first exemplary embodiment.

FIGS. 15A and 15B are diagrams illustrating a state where a latch, a latch spring, and a latch cover are attached according to the first exemplary embodiment.

FIG. 16 is a diagram illustrating a state where the rear door is closed according to the first exemplary embodiment.

FIG. 17 is a diagram illustrating the latch and the rear door interlocking lever that are interlocked when the rear door is opened according to the first exemplary embodiment.

FIG. 18 is a diagram illustrating the rear door interlocking lever and the fixing interlocking lever that are interlocked when the rear door is opened according to the first exemplary embodiment.

FIG. 19 is a diagram illustrating a state where pressure release of the fixing device is completed when the rear door is opened according to the first exemplary embodiment.

FIG. 20 is a diagram illustrating a state caused when the latch is separated from the rear door interlocking lever according to the first exemplary embodiment.

FIG. 21 is a diagram illustrating the movement of the rear door interlocking lever after separation according to the first exemplary embodiment.

FIG. 22 is a diagram illustrating a relationship between a rear door guide and the fixing interlocking lever when the rear door is closed according to the first exemplary embodiment.

FIG. 23 is a diagram illustrating an operation of the pressure release cam that is performed when the rear door is closed according to the first exemplary embodiment.

FIG. 24 is a diagram illustrating a state where the latch and the rear door interlocking lever are separated when the rear door is closed according to the first exemplary embodiment.

FIG. 25 is a diagram illustrating a relationship between the latch and the rear door interlocking lever when the rear door is closed according to the first exemplary embodiment.

FIG. 26 is a diagram illustrating a state where the latch is retracted when the rear door is closed according to the first exemplary embodiment.

FIG. 27 is a diagram illustrating a state where the latch and the rear door interlocking lever return to an engaged state when the rear door is closed according to the first exemplary embodiment.

FIG. 28 is a diagram illustrating a fixing left cover according to a second exemplary embodiment.

FIG. 29 is a diagram of a rear door interlocking lever according to the second exemplary embodiment.

FIGS. 30A and 30B are diagrams illustrating the movement of the rear door interlocking lever after separation according to the second exemplary embodiment.

FIG. 31 is a diagram illustrating a fixing interlocking lever according to a third exemplary embodiment.

FIG. 32 is a diagram illustrating a rear door interlocking lever according to the third exemplary embodiment.

FIGS. 33A and 33B are diagrams illustrating the movement of the rear door interlocking lever after separation according to the third exemplary embodiment.

### DESCRIPTION OF THE EMBODIMENTS

A first exemplary embodiment will be described. As an example of a configuration of an image forming apparatus according to the present disclosure, an exemplary embodiment, features, and aspects in which the present disclosure is applied to an electrophotographic laser printer will be specifically described with reference to the drawings. As the order of description, an overall configuration of an image forming apparatus according to the present disclosure will be described first, and the configuration of a fixing device of the image forming apparatus according to the present disclosure will be described next.

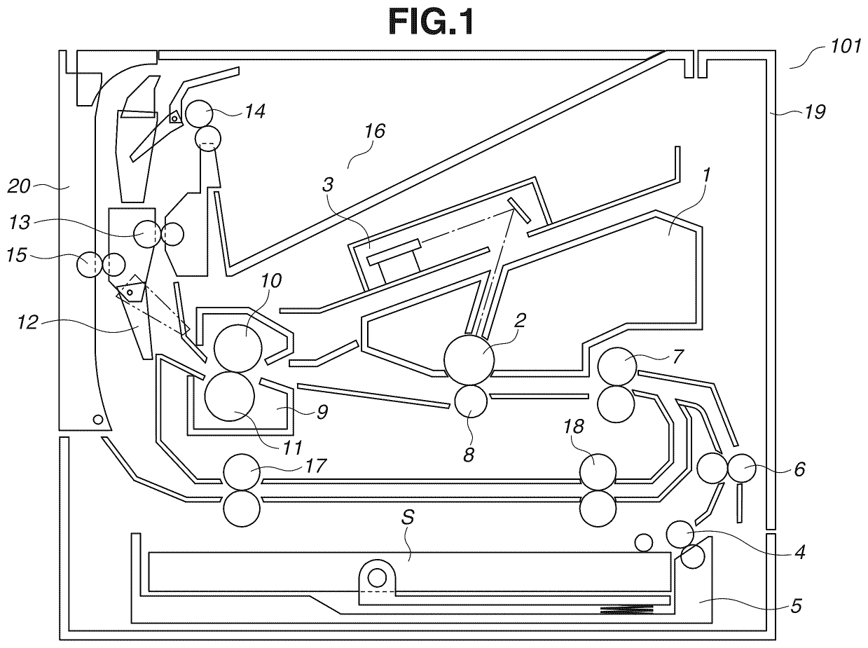

FIG. 1 is a sectional view illustrating a configuration of an electrophotographic laser printer having a duplex image forming function, to which the present disclosure is applied, as an example of an image forming apparatus according to an exemplary embodiment. Note that the dimensions, materials, shapes, and relative arrangement of the components described in the exemplary embodiment are not intended to limit the scope of the disclosure to those unless otherwise specified. The image forming apparatus according to an exemplary embodiment of the present disclosure is not limited to the laser printer, and the present disclosure may be applied to other image forming apparatuses such as a copier, a facsimile, or the like.

Broadly speaking, an image forming apparatus 101 illustrated in FIG. 1 includes a sheet feeding unit, an image forming unit that forms an image onto a sheet, a fixing unit, a discharge reversing unit, and a duplex conveyance unit. The image forming apparatus 101 includes a process cartridge 1 attachable to and detachable from an apparatus main body. The process cartridge 1 is a process unit for forming a toner image on a sheet using an electrophotographic process, and includes process components such as a photosensitive drum 2, a development unit (not illustrated), and a charging roller (not illustrated). A scanner unit 3 is arranged above the process cartridge 1 in a vertical direction, and performs exposure of the photosensitive drum 2 based on an image signal. After the photosensitive drum 2 is charged to a predetermined negative-polarity potential by the charging roller (not illustrated), an electrostatic latent image is formed on the photosensitive drum 2 by the scanner unit 3. The electrostatic latent image is reversely developed by the development unit (not illustrated) in the process cartridge 1, negative-polarity toner is attached, and a toner image is formed.

The sheet feeding unit includes a sheet feeding roller 4 attached to the image forming apparatus 101, and a sheet feeding cassette 5 that is attachable to and detachable from the image forming apparatus 101 and stores sheets. Sheets S stored in the sheet feeding cassette 5 are separated and fed one by one from the sheet feeding cassette 5 by the sheet feeding roller 4 rotated by dynamic force of a sheet feeding drive unit (not illustrated). The fed sheet S is conveyed by a conveyance roller pair 6 to a registration roller pair 7, subjected to skew correction by the registration roller pair 7, and conveyed to a transfer unit.

In the transfer unit, a positive-polarity bias is applied to a transfer roller 8 by a bias application unit (not illustrated). With this configuration, a toner image is transferred as an unfixed image to the sheet S conveyed to the transfer unit.

The sheet S bearing the transferred toner image is conveyed to a fixing device (fixing unit) 9 provided on the downstream side in a conveyance direction of the transfer unit. The fixing device 9 is for fixing the toner image transferred to the sheet S, and includes a heating unit (pressed member) 10 serving as a fixing member to be heated by a heater (not illustrated) serving as a heating unit, and a pressing roller (pressing member) 11 that rotates in press contact with the heating unit 10. By conveying the sheet S nipped by a fixing nip portion formed by the heating unit 10 and the pressing roller 11 and applying heat and pressure to the toner image, the toner image is fixed to the surface of the sheet S. Alternatively, the pressing member may be heated instead of the pressed member by the heater.

The sheet S bearing the fixed toner image is conveyed from the fixing device 9 to the discharge reversing unit. In the case of simplex image formation (simplex printing), a duplex flapper 12 stands by at a position (solid-line position) where the duplex flapper 12 guides the sheet S toward an intermediate conveyance roller pair 13. The sheet S bearing the fixed toner image is conveyed from the fixing device 9 to the intermediate conveyance roller pair 13, and discharged by a discharge roller pair 14 onto a discharge stacking tray 16.

In the case of duplex image formation (duplex printing), the duplex flapper 12 stands by at a position (dotted-line position) where the duplex flapper 12 guides the sheet S toward a duplex reversing roller pair 15, and the sheet S is conveyed by the fixing device 9 toward the duplex reversing roller pair 15. The duplex reversing roller pair 15 is reversely rotated by a rotational direction switching unit (not illustrated) at a timing at which the read end of the sheet S reaches a predetermined position. With this configuration, the sheet S passes through a duplex conveyance roller pair 17 and a sheet refeeding roller pair 18 with its trailing edge at the head, and is refed to the registration roller pair 7 in a reversed state. Then, similarly to the simplex printing, the sheet S is subjected to skew correction performed by the registration roller pair 7, a toner image is transferred to the second surface of the sheet S by the transfer roller 8, the toner image is fixed by the fixing device 9, the sheet S is discharged by the discharge roller pair 14 onto the discharge stacking tray 16, and duplex printing is completed. In a case where a jam occurs in the apparatus main body during sheet conveyance, jam processing is performed by opening a front door 19 or a rear door 20 in accordance with a location where the jam has occurred.

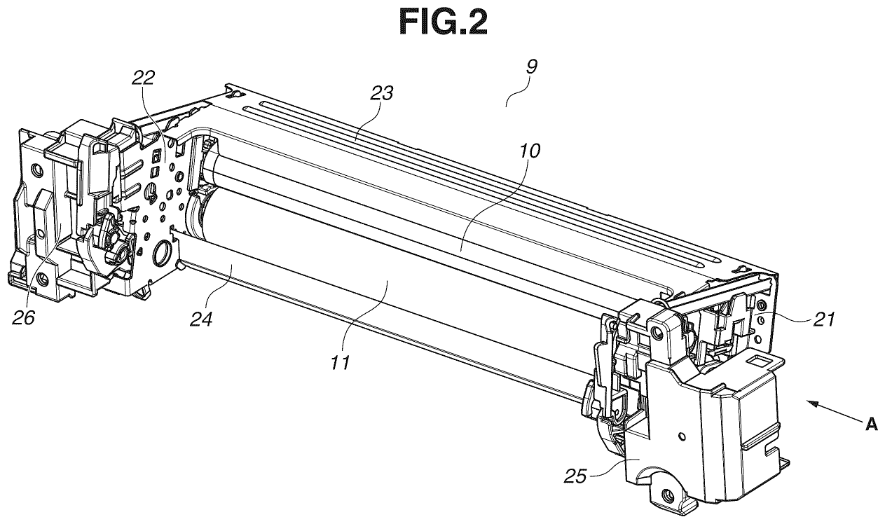

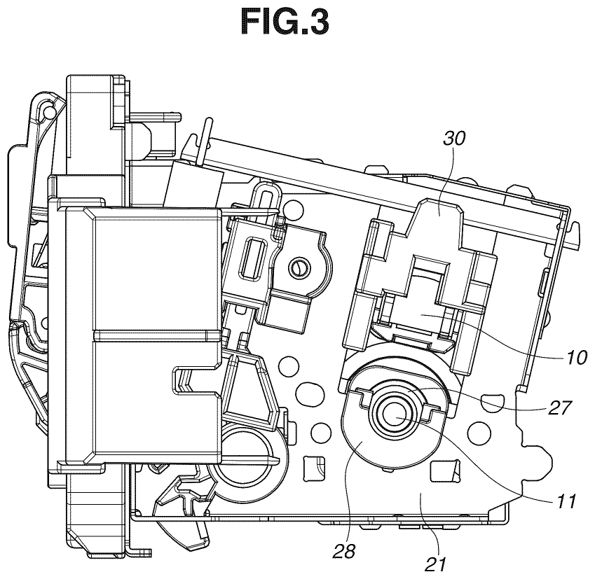

Next, a fixing device according to an exemplary embodiment of the present disclosure will be described with reference to FIGS. 2 to 11. In the following description, the illustration of a fastener member such as a screw is omitted. FIGS. 2 to 3 are schematic diagrams illustrating a fixing device according to the first exemplary embodiment, where FIG. 2 is a perspective view, and FIG. 3 is a side view illustrating the fixing device viewed from an A direction in FIG. 2. In FIG. 2, a frame member of the fixing device 9 include a fixing first side panel 21, a fixing second side panel 22, a fixing upper stay 23, and a fixing lower stay 24. To protect a plate edge from users, a fixing left cover (cover member) 25 and a fixing right cover 26 are fastened and attached by screws (not illustrated) to the fixing first side panel 21 and the fixing second side panel 22, respectively. In FIG. 3, the pressing roller 11 is rotatably supported on the fixing first side panel 21 and the fixing second side panel 22 via a ball bearing 27 and a pressing roller bearing 28. The heating unit 10 is attached to the fixing first side panel 21 and the fixing second side panel 22 via a flange member 30, and by being arranged on an opposed side of the pressing roller 11, the heating unit 10 forms a nip portion and nips the sheet S.

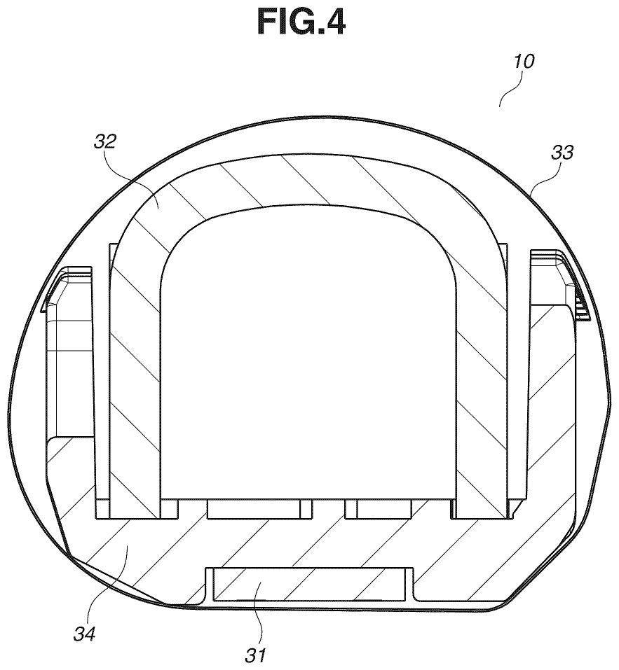

FIG. 4 is a cross-sectional view illustrating a configuration of the heating unit 10. The heating unit 10 mainly includes a heater 31, a pressing stay 32, a fixing film 33, and a film guide 34. The fixing film 33 has a cylindrical shape (endless belt shape, sleeve shape) and flexibility, and is loosely fitted over the film guide 34. The heater 31 serving as a heat source is fixed by being fitted into a recess groove portion provided along a longer direction of an external surface of the film guide 34. The pressing stay 32 has an approximately U-shaped cross-sectional shape, is arranged on the inner side of the film guide 34, and presses the film guide 34 and the heater 31 toward the pressing roller 11 when pressing force is received.

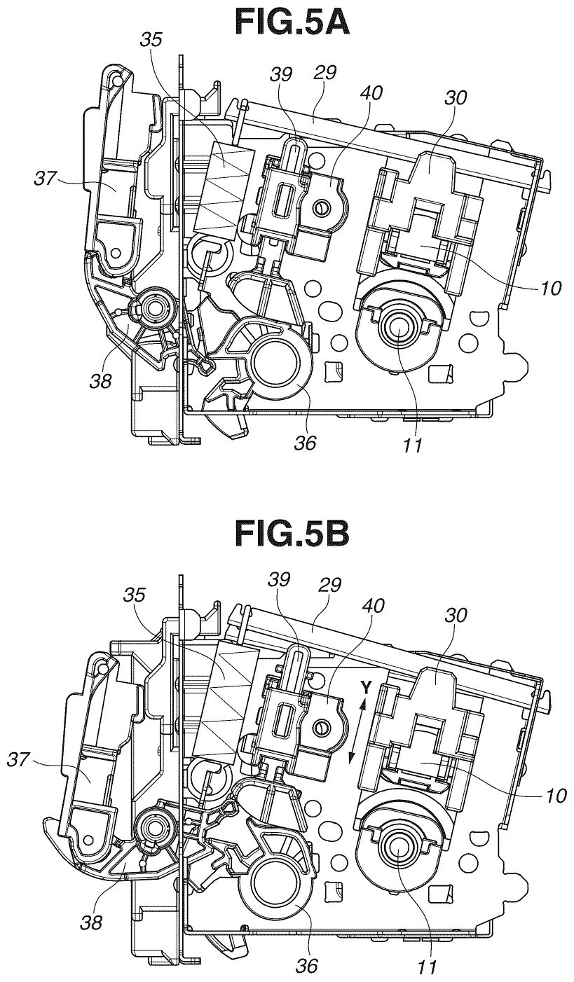

FIGS. 5A and 5B are side views illustrating the fixing device 9 viewed from the A direction in FIG. 2, and are diagrams illustrating a pressed state and a pressure release state of the fixing device 9. FIG. 5A is a diagram illustrating a contact state where predetermined pressing force is applied to the fixing nip portion, and FIG. 5B is a diagram illustrating a pressure release state where pressing force to applied to the fixing nip portion is reduced from the predetermined pressing force in the contact state or released. For the sake of explanatory convenience, the illustration of a fixing left cover 25 is omitted.

As a pressing mechanism of the fixing device 9, the heating unit 10 is biased by a pressing spring 35 toward the pressing roller 11 via a pressing plate 29 and the flange member 30. A pressing force adjustment unit of the fixing device 9 includes a pressure release cam (cam member) 36, the pressing plate 29, a pressure release arm 39, and a pressure release arm holder 40. As interlocking members, a rear door interlocking lever (second interlocking member) 37 and a fixing interlocking lever (first interlocking member) 38 are also arranged in the fixing device 9. When the pressure in the fixing device 9 is released, the rotation of the rear door interlocking lever 37 rotates the pressure release cam 36 that rotates around a bearing member (not illustrated), via the fixing interlocking lever 38. Then, by converting an amount of variation in a radial direction caused by the rotation of the pressure release cam 36, into a variation amount in a Y direction by the pressure release arm 39, the position of the pressing plate 29 switches from the contact state illustrated in FIG. 5A, to the pressure release state illustrated in FIG. 5B. The pressure release arm 39 is held by pressure release arm holder 40 to be movable only in the Y direction.

The pressing plates 29, the pressing springs 35, the pressure release cams 36, the rear door interlocking levers 37, the fixing interlocking levers 38, the pressure release arms 39, and the pressure release arm holders 40 are arranged on both sides in the longer direction of the fixing device 9. The pressure release arm 39 may be formed as one component, may include a plurality of components, and may be formed by power transmission systems such as a plurality of gears.

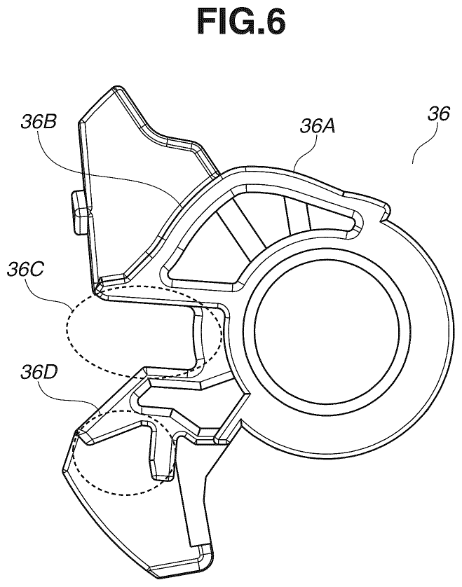

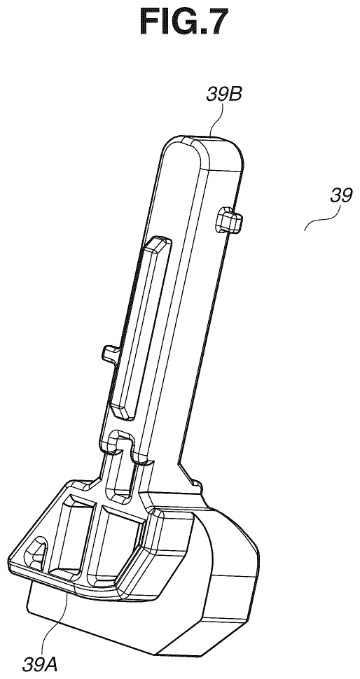

FIGS. 6 and 7 are diagrams illustrating the details of the members of the pressing force adjustment unit, FIG. 6 is a diagram of the pressure release cam 36, and FIG. 7 is a diagram of pressure release arm 39. In FIG. 6, the pressure release cam 36 includes a first arc portion 36A that comes into contact with the pressure release arm 39 when the nip portion is in the contact state, and a second arc portion 36B that comes into contact with the pressure release arm 39 when the nip portion is in the pressure release state. As a relationship between the first arc portion 36A and the second arc portion 36B, both the first arc portion 36A and the second arc portion 36B are concentric with the rotational axis of the cam, and a radius of the second arc portion 36B is larger than a radius of the first arc portion 36A. The pressure release cam 36 includes a first engaged portion 36C and a second engaged portion 36D to be interlocked with the opening and closing of the rear door 20 via the rear door interlocking lever 37 and the fixing interlocking lever 38.

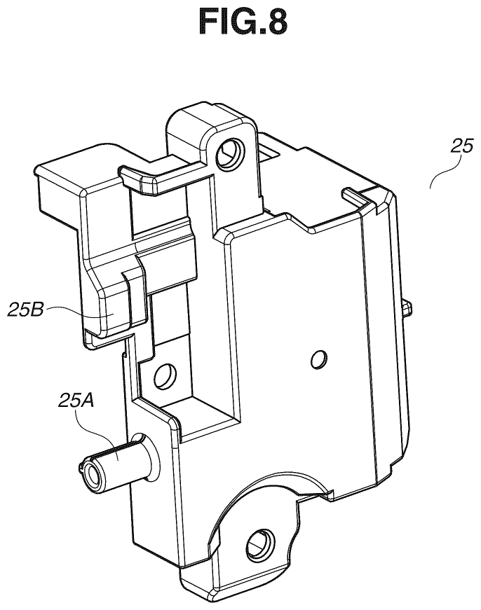

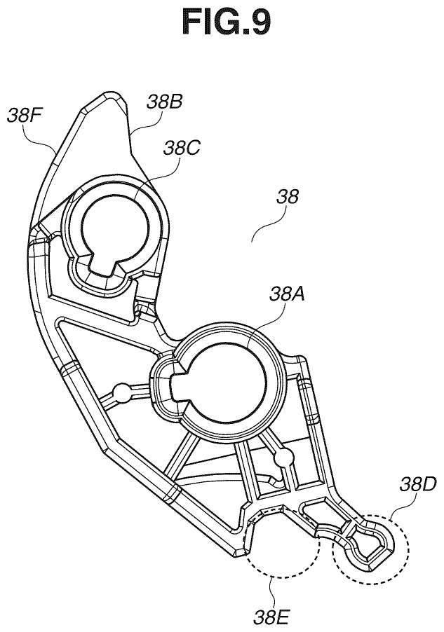

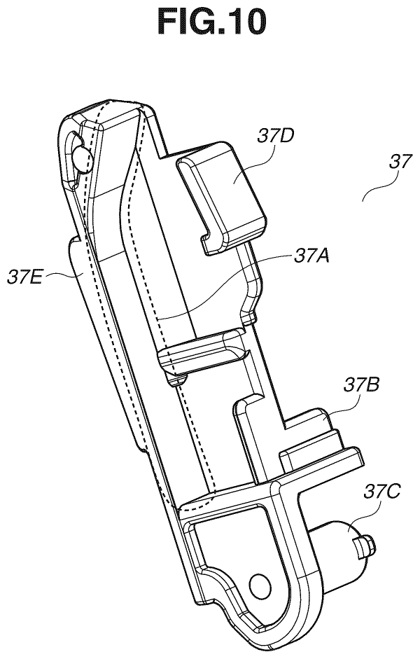

In FIG. 7, the pressure release arm 39 includes a cam contact portion 39A that comes into contact with the pressure release cam 36, and a pressing plate contact portion 39B that comes into contact with the pressing plate 29. FIGS. 8 to 10 are diagrams illustrating the details of the members of the interlocking member, FIG. 8 is a diagram of the fixing left cover 25, FIG. 9 is a diagram of the fixing interlocking lever 38, and FIG. 10 is a diagram of the rear door interlocking lever 37. In FIG. 8, the fixing left cover 25 includes a cover rotation central shaft 25A of approximately circular shape for rotatably supporting the fixing interlocking lever 38, and a butted portion 25B for stopping rotation of the rear door interlocking lever 37.

In FIG. 9, the fixing interlocking lever 38 includes a first rotational center hole 38A of approximately circular shape to be fitted with the cover rotation central shaft 25A of the fixing left cover 25, an engaged portion 38B for interlocking with the rear door interlocking lever 37 when the rear door 20 is opened, a second rotational center hole 38C of approximately circular shape for rotatably supporting the rear door interlocking lever 37, and a first engagement portion 38D and a second engagement portion 38E for interlocking the opening and closing of the rear door 20 with the pressure release cam 36. The fixing interlocking lever 38 also includes a pressed portion 38F to be rotated by being pressed from a rear door guide 44 when the rear door 20 is closed.

In FIG. 10, the rear door interlocking lever 37 includes an engagement portion (third engagement portion) 37A for interlocking with the rear door 20 when the rear door 20 is opened, a second lever engagement portion 37B for interlocking an opening operation of the rear door 20 with the fixing interlocking lever 38, a rotation central shaft 37C of approximately circular shape to be fitted into the second rotational center hole 38C of the fixing interlocking lever 38, and a rotation stop portion 37D for stopping rotation by butting the butted portion 25B of the fixing left cover 25. The rear door interlocking lever 37 also includes a surface 37E that comes into contact with the rear door 20 when the rear door 20 is closed.

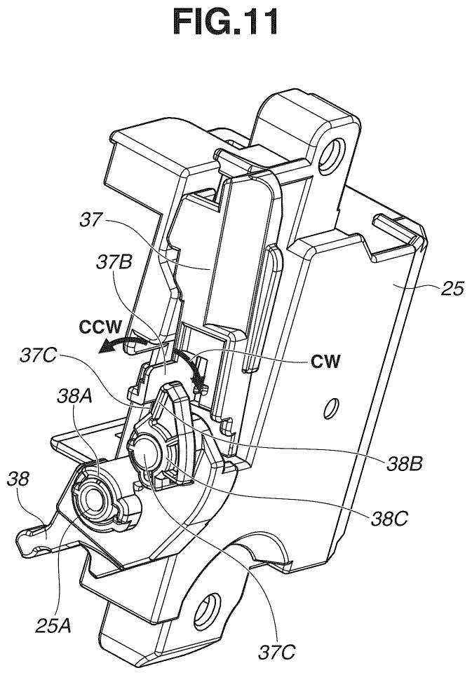

FIG. 11 is a diagram illustrating the configuration of the interlocking member. In FIG. 11, the fixing interlocking lever 38 is rotatably supported by the first rotational center hole 38A being fitted with the cover rotation central shaft 25A of the fixing left cover 25. The rear door interlocking lever 37 is rotatably supported by the rotation central shaft 37C being fitted into the second rotational center hole 38C of the fixing interlocking lever 38. The second lever engagement portion 37B of the rear door interlocking lever 37 engages with the engaged portion 38B of the fixing interlocking lever 38. As a relationship between the second lever engagement portion 37B and the engaged portion 38B, in a clockwise (CW) direction (first rotational direction) which is a rotational direction in which the pressure to the fixing device 9 is released, the second lever engagement portion 37B and the engaged portion 38B butt each other to be engaged, and in a counterclockwise (CCW) direction (second rotational direction) which is an opposite direction to the CW direction, the second lever engagement portion 37B and the engaged portion 38B are not engaged. Accordingly, the rear door interlocking lever 37 is configured to be rotatable in the CCW direction independently of the fixing interlocking lever 38 and the pressure release cam 36.

While the components on one side in the longer direction of the fixing device 9 have been described, a relationship between the fixing right cover 26, the rear door interlocking lever 37, and the fixing interlocking lever 38 on the opposite side in the longer direction also has a similar configuration.

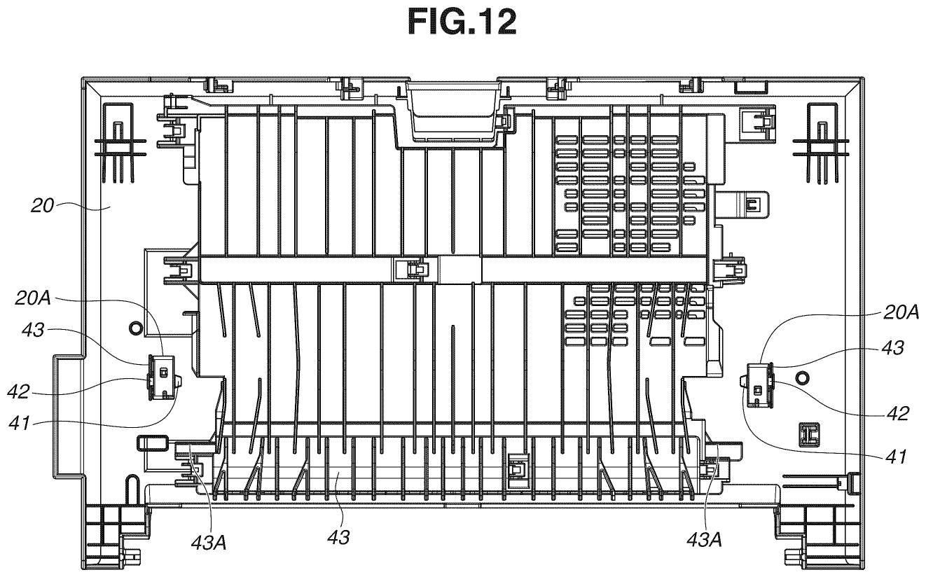

FIG. 12 is a diagram illustrating a configuration of the rear door 20. The rear door 20 includes latches 41 serving as an engagement member, latch springs (second biasing member) 42, latch covers 43, and the rear door guide 44. The latches 41, the latch springs 42, and the latch covers 43 are accommodated in latch accommodation portions 20A arranged on the rear door 20, and respectively arranged at longer direction positions corresponding to two rear door interlocking levers 37 arranged in the longer direction of the fixing device 9. The rear door guide 44 includes a pressing portion 44A for pressing the pressed portion 38F of the fixing interlocking lever 38 when the rear door 20 is closed. In the present exemplary embodiment, the rear door guide 44 is a separate component from the rear door 20, but the shape of the rear door guide 44 may be formed integrally with the rear door 20.

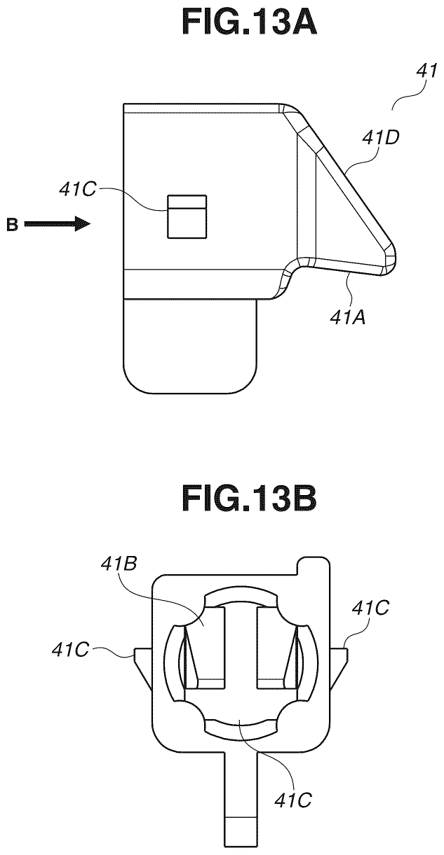

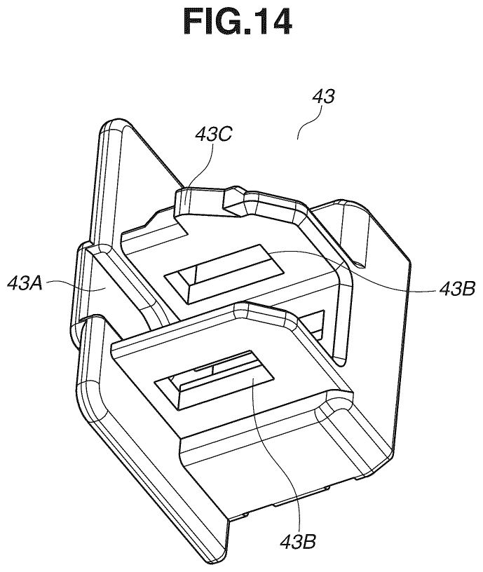

FIGS. 13A and 13B, and 14 are diagrams illustrating the details of the members of the rear door 20, FIGS. 13A and 13B are diagrams illustrating the latch 41, and FIG. 14 is a diagram illustrating the latch cover 43. FIG. 13B is a diagram illustrating the latch 41 viewed from a B direction in FIG. 13A. In FIGS. 13A and 13B, the latch 41 includes a door engagement portion 41A for engaging with the first lever engagement portion 37A to interlock the operation of opening the rear door 20 with the rear door interlocking lever 37, a receiving hole 41B for arranging the latch spring 42 and receiving biasing force of the latch spring 42, and a projection portion 41C for preventing the latch 41 from slipping from the latch accommodation portion 20A by the biasing force of the latch spring 42. The latch 41 also includes a contact portion 41D for retracting the latch 41, and the contact portion 41D comes into contact with the rear door interlocking lever 37 when the rear door 20 is closed.

In FIG. 14, the latch cover 43 includes a spring bearing surface 43A for arranging the latch spring 42, a regulation portion 43B for preventing the latch 41 from slipping from the latch accommodation portion 20A by the biasing force of the latch spring 42, and a retaining portion 43C for preventing the latch cover 43 from slipping from the latch accommodation portion 20A by the biasing force of the latch spring 42.

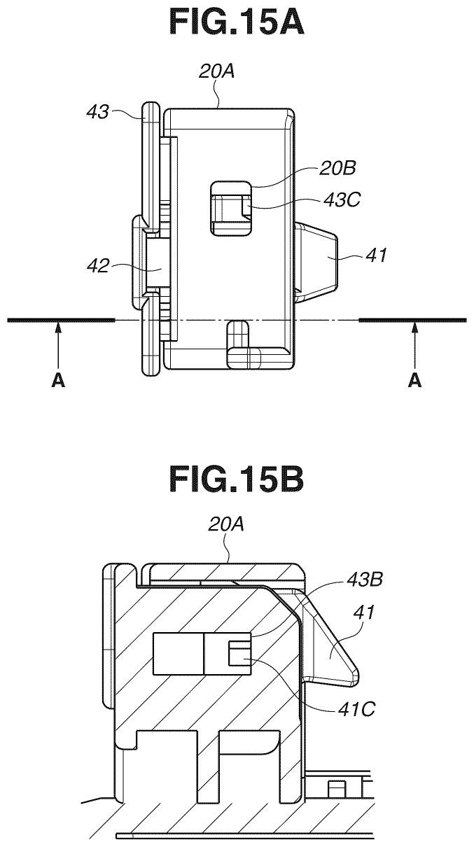

FIGS. 15A and 15B are diagrams illustrating a state where the latch 41, the latch spring 42, and the latch cover 43 are attached, FIG. 15A is a front view, and FIG. 15B is a cross-sectional view taken along an A-A line in FIG. 15A. In FIGS. 15A and 15B, the latch 41 is biased toward the A direction by the biasing force of the latch spring 42. To prevent the latch 41 from slipping from the latch accommodation portion 20A by the biasing force of the latch spring 42, the projection portion 41C of the latch 41 and the regulation portion 43B of the latch cover 43 come into contact with each other, and performs retaining. To prevent the latch cover 43 from slipping by the biasing force of the latch spring 42, the retaining portion 43C of the latch cover 43 catches on the latch cover regulation portion 20B of the rear door 20, and performs retaining. With such a configuration, the latch 41 is configured to be biased in a direction in which the latch 41 engages with the rear door interlocking lever 37, by the biasing force of the latch spring 42.

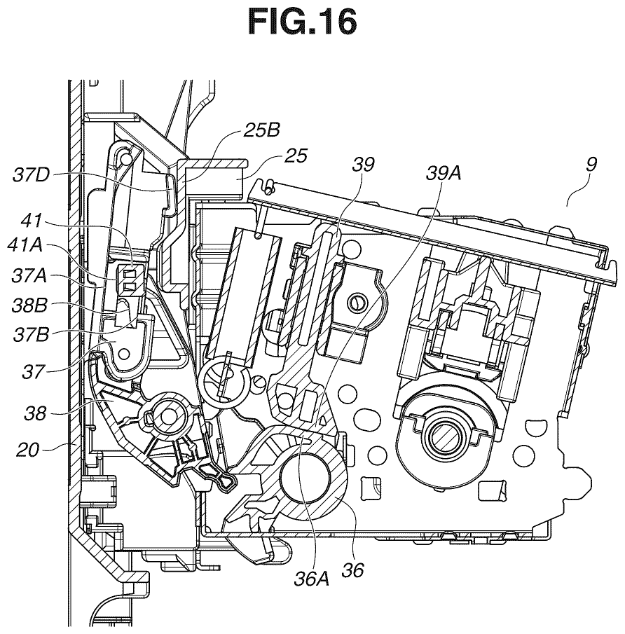

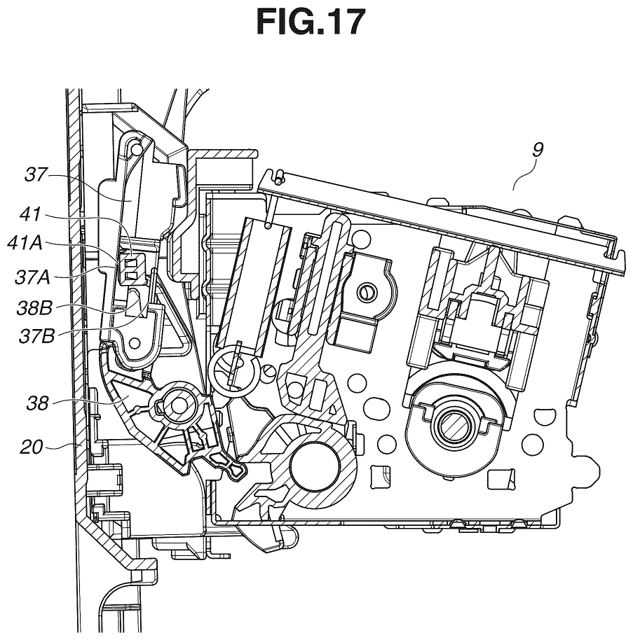

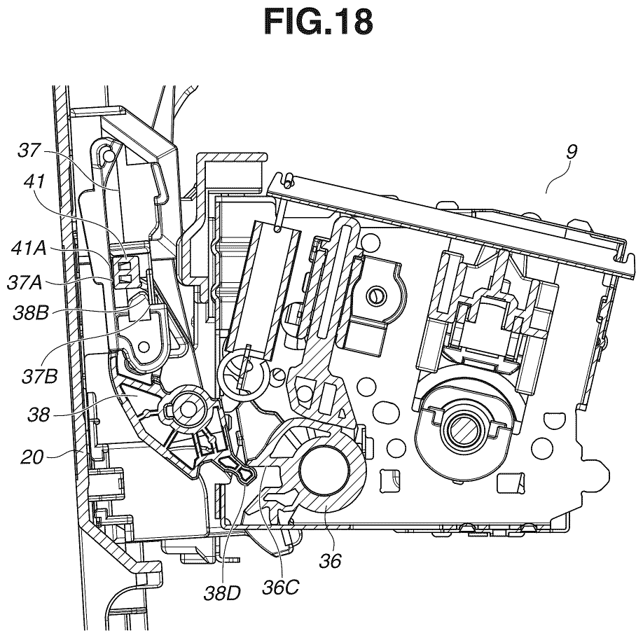

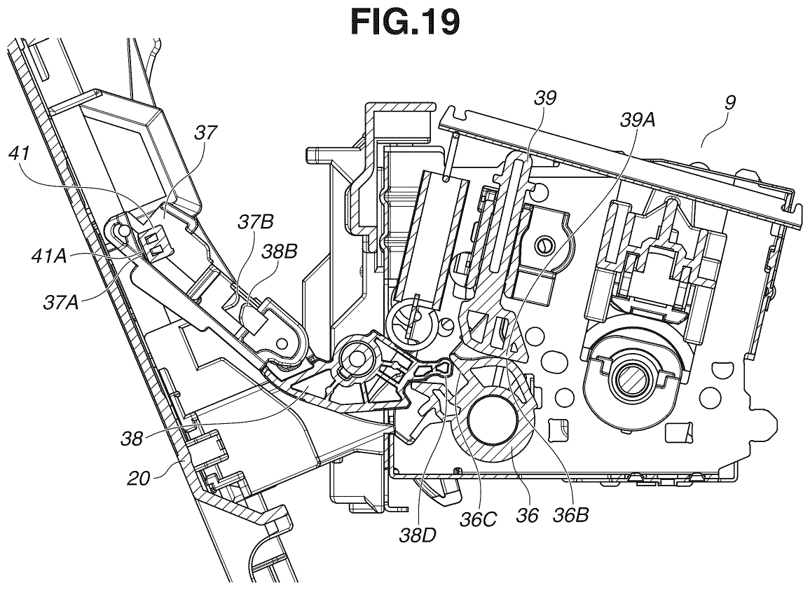

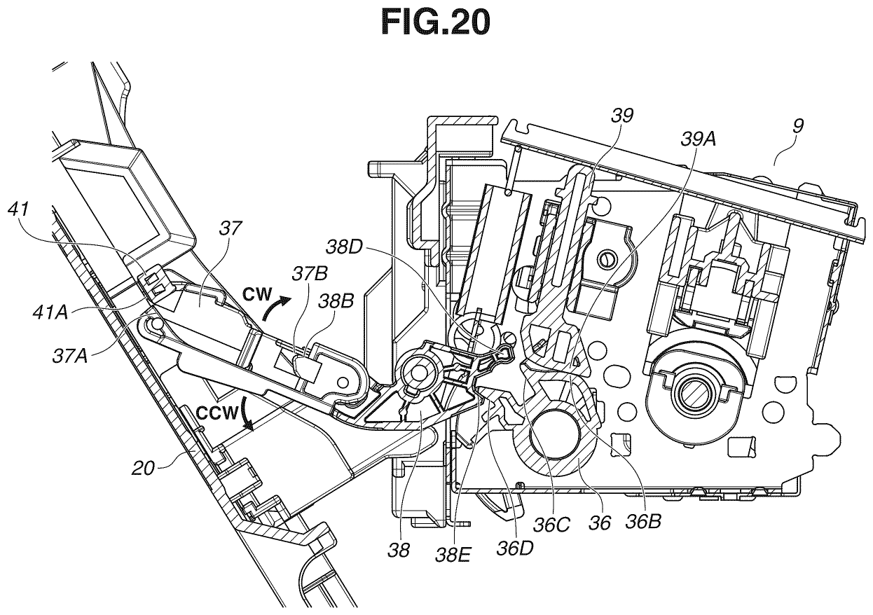

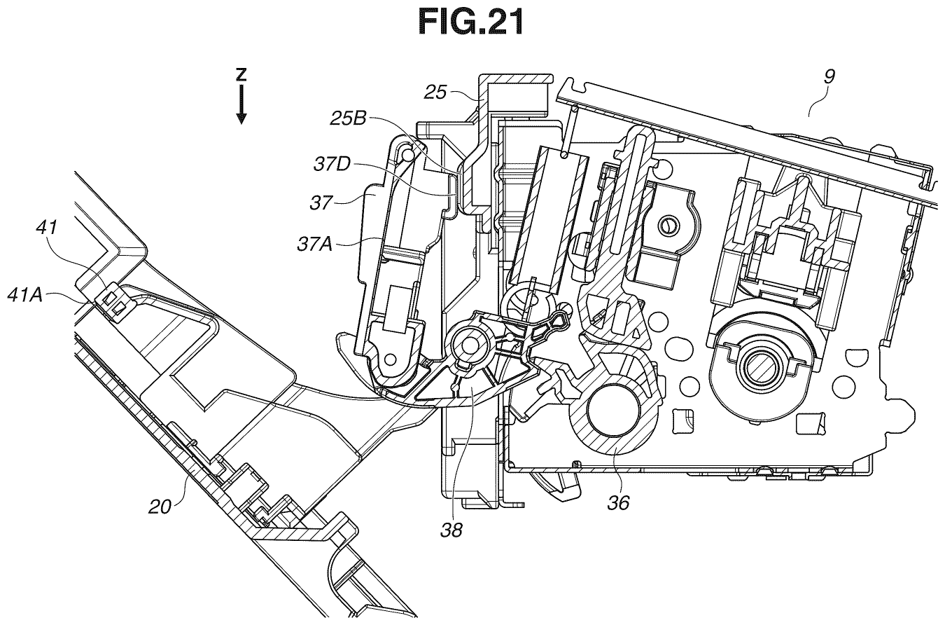

The interlocking of the rear door 20 and the fixing device 9 for pressure release when the rear door 20 is opened will be described with reference to FIGS. 16 to 21. FIGS. 16 to 21 are sectional views of a portion of the pressure release cam 36 in the longer direction of the fixing device 9. For the sake of explanatory convenience, the shape of the rear door interlocking lever 37 is partially deleted. FIG. 16 is a diagram illustrating a state where the rear door 20 is closed, FIG. 17 is a diagram illustrating a state where the rear door 20 starts to open and the latch 41 and the rear door interlocking lever 37 start to interlock with each other, FIG. 18 is a diagram illustrating a state where the rear door interlocking lever 37 and the fixing interlocking lever 38 start to interlock with each other, FIG. 19 is a diagram illustrating a state where pressure release of the fixing device 9 is completed, FIG. 20 is a diagram illustrating a state where the latch 41 gets separated from the rear door interlocking lever 37, and FIG. 21 is a diagram illustrating a state where the rear door interlocking lever 37 moves after the latch 41 and the rear door interlocking lever 37 are separated. The position of the pressing force adjustment unit in FIG. 16 is assumed to be a first position, for example, and the fixing unit is assumed to be in a first state, for example. The position of the pressing force adjustment unit in FIG. 21 is assumed to be a second position, for example, and the fixing unit is assumed to be in a second state, for example.

In FIG. 16, when the rear door 20 is closed, the door engagement portion 41A of the latch 41 and the first lever engagement portion 37A of the rear door interlocking lever 37 are not in contact with each other. Also, the second lever engagement portion 37B of the rear door interlocking lever 37 and the engaged portion 38B of the fixing interlocking lever 38 are not in contact with each other. In a state where the rear door 20 is closed, the nip portion in the fixing device 9 is in the contact state.

If the rear door 20 is opened from the state illustrated in FIG. 16, to the state illustrated in FIG. 17, the door engagement portion 41A of the latch 41 and the first lever engagement portion 37A of the rear door interlocking lever 37 come into contact with each other. That is, from this state, the latch 41 and the rear door interlocking lever 37 start to interlock with each other. Because the rear door interlocking lever 37 and the fixing interlocking lever 38 are not rotating at this timing, the nip portion in the fixing device 9 remains in the contact state.

If the rear door 20 is opened from the state illustrated in FIG. 17, because the rear door interlocking lever 37 is in a state of being engaged with the latch 41, the rear door interlocking lever 37 rotates in tandem with the rear door 20. Then, if the rear door 20 is opened to the state illustrated in FIG. 18, the second lever engagement portion 37B of the rear door interlocking lever 37 comes into contact with the engaged portion 38B of the fixing interlocking lever 38, and from this timing, the rear door interlocking lever 37 and the fixing interlocking lever 38 start to interlock with each other. Accordingly, if the rear door 20 is further opened from this state, the first engagement portion 38D of the fixing interlocking lever 38 presses the first engaged portion 36C of the pressure release cam 36 and the pressure release cam 36 rotates, and the pressure release of the fixing device 9 is started.

After that, if the rear door 20 is further opened, in tandem with the opening operation of the rear door 20, the latch 41 rotates the rear door interlocking lever 37 and the fixing interlocking lever 38, and the pressure release cam 36 also rotates. Then, if the rear door 20 is opened to the state illustrated in FIG. 19, the pressure release cam 36 enters a state where the second arc portion 36B comes into contact with the cam contact portion 39A of the pressure release arm (moving member) 39. If the pressure release cam 36 rotates to this state, the pressure release of the fixing device 9 is completed. At this timing, the latch 41 is still engaged with the rear door interlocking lever 37.

If the rear door 20 is further opened from the state illustrated in FIG. 19, the rear door interlocking lever 37, the fixing interlocking lever 38, and the pressure release cam 36 are further rotated by the latch 41. Then, if the rear door 20 is opened to the state illustrated in FIG. 20, the door engagement portion 41A of the latch 41 and the first lever engagement portion 37A of the rear door interlocking lever 37 get separated from each other. Here, the pressure release cam 36 is further rotated from the state illustrated in FIG. 19, but because the second arc portion 36B is in contact with the cam contact portion 39A of the pressure release arm 39 also in the state illustrated in FIG. 20, the fixing device 9 remains in the pressure release state. Because the second arc portion 36B is concentric with a rotational axis center of the cam, even after the latch 41 and the rear door interlocking lever 37 are separated, the fixing device 9 maintains the pressure release state. During a process from FIG. 19 to FIG. 20, the first engagement portion 38D of the fixing interlocking lever 38 gets separated from the first engaged portion 36C of the pressure release cam 36, and interlocking is performed with an engagement point being switched to an engagement point between the second engagement portion 38E of the fixing interlocking lever 38 and the second engaged portion 36D of the pressure release cam 36.

If the state illustrated in FIG. 20 is caused, because the rear door interlocking lever 37 gets separated from the latch 41, biasing force in the CCW direction in FIG. 20 is no longer applied. The second lever engagement portion 37B of the rear door interlocking lever 37 and the engaged portion 38B of the fixing interlocking lever 38 are engaged only in the CCW direction.

In other words, the rear door interlocking lever 37 can independently rotate in the CW direction without rotating the fixing interlocking lever 38 and the pressure release cam 36. Accordingly, for example, as illustrated in FIGS. 20 and 21, by an operation performed by the user or the like, the rear door interlocking lever 37 can rotate until the rotation stop portion 37D of the rear door interlocking lever 37 butts the butted portion 25B of the fixing left cover 25. In this state, because force for rotating the rear door interlocking lever 37 in a direction in which the rear door interlocking lever 37 butts the fixing left cover 25 is applied by its own weight, the state illustrated in FIG. 21 is maintained.

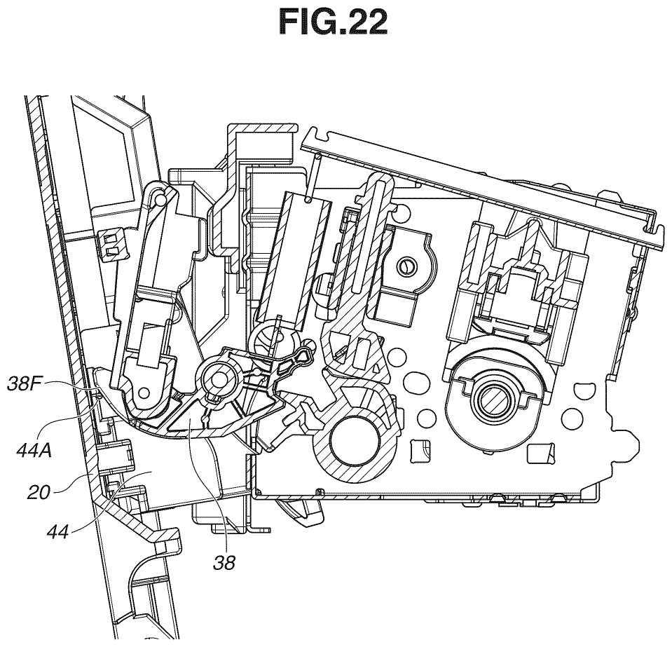

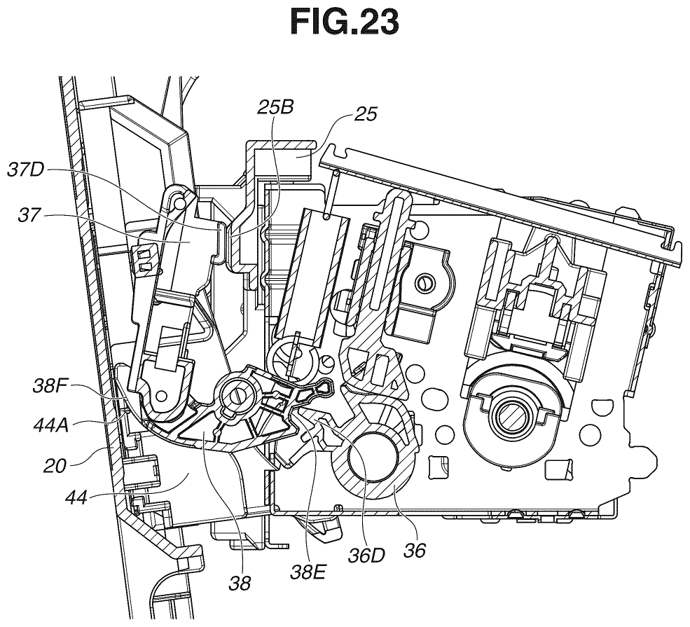

Next, operations of the fixing interlocking lever 38 and the pressing force adjustment unit that are to be performed when the rear door 20 is closed will be described with reference to FIGS. 22 and 23. FIG. 22 is a diagram illustrating a state caused at a timing at which the rear door guide 44 and the fixing interlocking lever 38 come into contact with each other, and FIG. 23 is a diagram illustrating a state caused at a timing at which the fixing interlocking lever 38 rotate to come into contact with the pressure release cam 36. If the rear door 20 is closed from the state illustrated in FIG. 21, as in the state illustrated in FIG. 22, the pressing portion 44A of the rear door guide 44 and the pressed portion 38F of the fixing interlocking lever 38 come into contact with each other.

If the rear door 20 is further closed from this state, the pressed portion 38F is pressed by the pressing portion 44A, and the fixing interlocking lever 38 rotates. If the fixing interlocking lever 38 rotates to the state illustrated in FIG. 23, the second engagement portion 38E of the fixing interlocking lever 38 presses the second engaged portion 36D of the pressure release cam 36 again, and the pressure release cam 36 rotates in the direction of the contact state. Then, the fixing interlocking lever 38 and the pressure release cam 36 return to the state illustrated in FIG. 16, the first arc portion 36A of the pressure release cam 36 comes into contact with the cam contact portion 39A of the pressure release arm 39, and the fixing device 9 returns to the contact state. The rear door interlocking lever 37 returns to the contact state illustrated in FIG. 16, while the rotation stop portion 37D slides on the butted portion 25B of the fixing left cover 25.

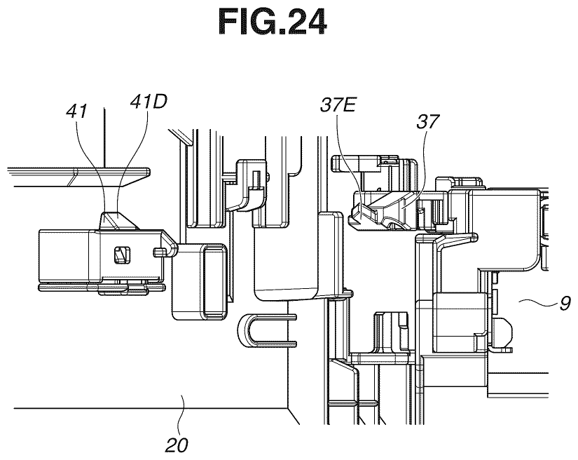

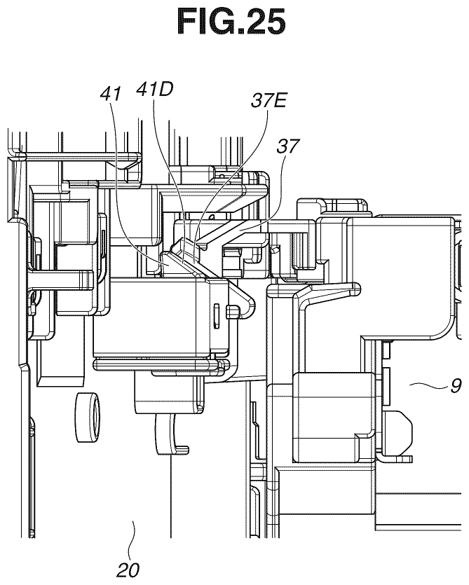

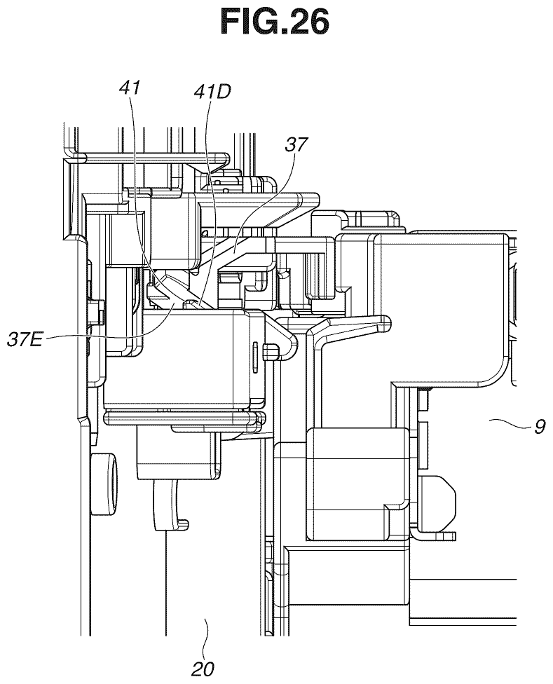

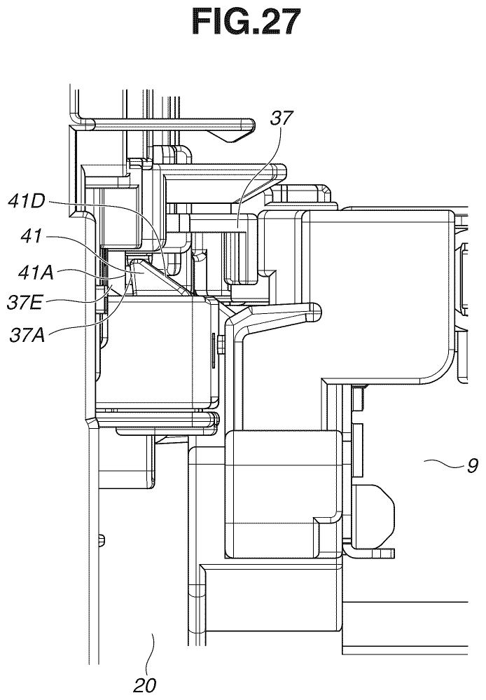

Next, an operation of the latch 41 to be performed when the rear door 20 is closed will be described with reference to FIGS. 24 to 27. FIGS. 24 to 27 are diagrams illustrating the rear door 20 and the fixing device 9 viewed from a Z direction in FIG. 21, FIG. 24 is a diagram illustrating a state where the latch 41 and the rear door interlocking lever 37 are separated from each other, FIG. 25 is a diagram illustrating a state at a timing which the latch 41 and the rear door interlocking lever 37 come into contact with each other, FIG. 26 is a diagram illustrating a state where the latch 41 is retracted, and FIG. 27 is a diagram illustrating a state where the latch 41 and the rear door interlocking lever 37 return to an engaged state. For the sake of explanatory convenience, the shape of the rear door interlocking lever 37 is partially deleted. If the rear door 20 is closed from the state illustrated in FIG. 24, as in the state illustrated in FIG. 25, the contact portion (contacted portion) 41D of the latch 41 comes into contact with the surface (contact portion) 37E of the rear door interlocking lever 37.

If the rear door is further closed from this state, as illustrated in FIG. 26, the contact portion 41D of the latch 41 is pressed by the surface 37E, and is retracted by overcoming the biasing force of the latch spring 42. After that, if the latch 41 gets over the surface 37E, as illustrated in FIG. 27, the latch 41 returns to the original state by the biasing force of the latch spring 42. Then, the door engagement portion 41A of the latch 41 and the first lever engagement portion 37A of the rear door interlocking lever 37 return again to the engaged state. A relationship between the door engagement portion 41A of the latch 41 and the first lever engagement portion 37A of the rear door interlocking lever 37 in FIG. 27 is similar to that in the state where the fixing device 9 is in the contact state in FIG. 16, and if the state is returned to the state where the rear door 20 is closed, the state returns to the state illustrated in FIG. 16.

In this manner, in the configuration of releasing pressing force of the fixing device 9 in tandem with the opening and closing of the rear door 20, by enabling the rear door interlocking lever 37 to independently rotate without rotating the pressure release cam 36 after the rear door interlocking lever 37 and the latch 41 are separated, a configuration can be adopted in which both of usability and a pressing force release configuration interlocked with the opening and closing of a door are achieved.

With the configuration of the present disclosure, it is possible to provide an image forming apparatus that achieves both of usability and a configuration of releasing pressing force of fixing in tandem with the opening and closing of a door.

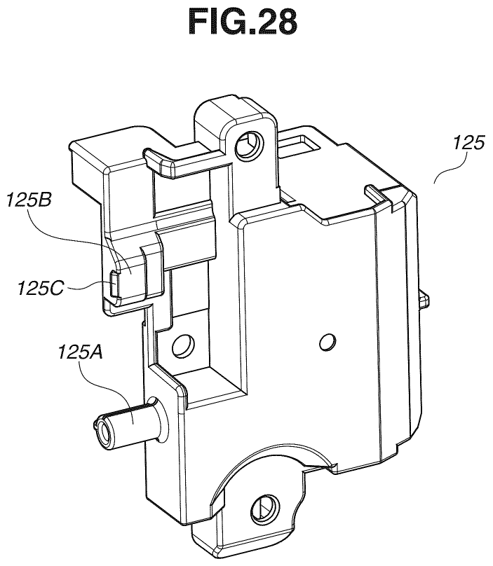

Next, a second exemplary embodiment of the present disclosure will be described with reference to FIGS. 28 to 30A and 30B. In the second exemplary embodiment, the description of components similar those in the first exemplary embodiment is omitted. A difference from the first exemplary embodiment lies in a configuration related to the movement of a rear door interlocking lever after a latch and the rear door interlocking lever are separated.

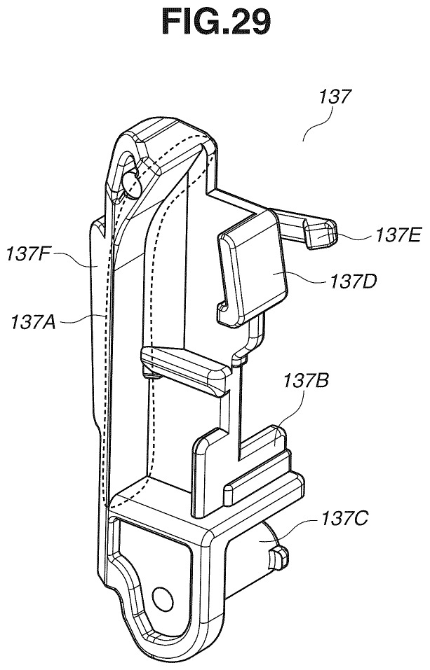

FIG. 28 is a diagram illustrating the shape of a fixing left cover, and FIG. 29 is a diagram illustrating the shape of a rear door interlocking lever. In FIG. 28, a fixing left cover 125 includes a cover rotation central shaft 125A of approximately circular shape for rotatably supporting the fixing interlocking lever 38, and a butted portion 125B for stopping rotation of a rear door interlocking lever 137. The fixing left cover 125 also includes a holding portion 125C for holding the rear door interlocking lever 137.

In FIG. 29, the rear door interlocking lever 137 includes a first lever engagement portion 137A for interlocking with the rear door 20 when the rear door 20 is opened, a second lever engagement portion 137B for interlocking an opening operation of the rear door 20 with the fixing interlocking lever 38, and a rotation central shaft 137C of approximately circular shape to be fitted into the second rotational center hole 38C of the fixing interlocking lever 38. The rear door interlocking lever 137 also includes a rotation stop portion 137D for stopping rotation by butting the butted portion 125B of the fixing left cover 125, and a hook portion 137E for holding the orientation by being hooked on the holding portion 125C of the fixing left cover 125. The rear door interlocking lever 137 further includes a surface 137F for retracting the latch 41, and the surface 137F comes into contact with the latch 41 when the rear door 20 is closed.

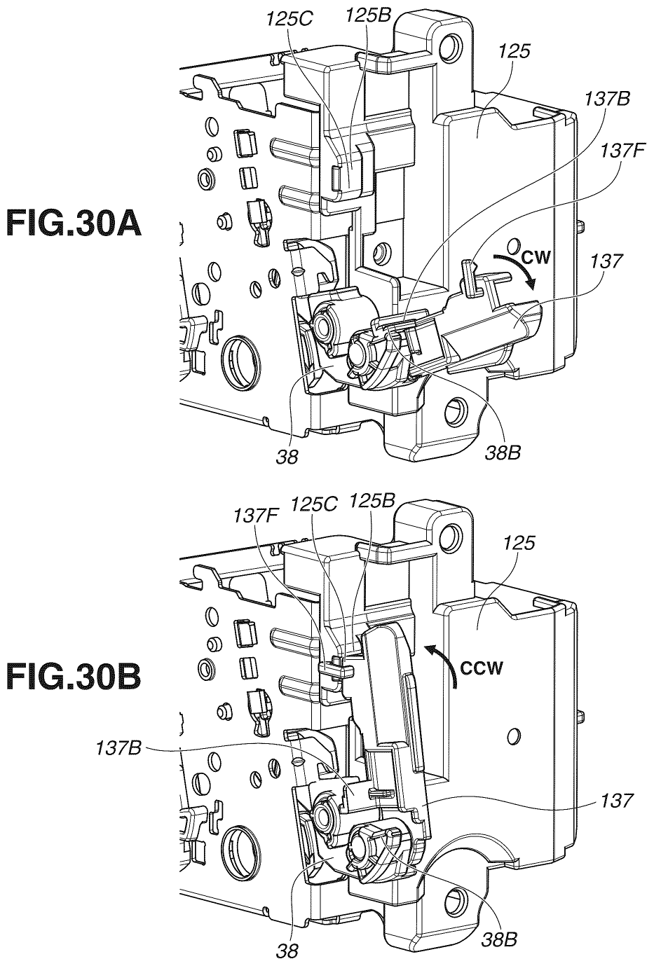

FIGS. 30A and 30B are diagrams illustrating the configuration of the movement of the rear door interlocking lever 137 after the latch 41 and the rear door interlocking lever 137 are separated from each other. After the rear door interlocking lever 137 is separated from the latch 41, the second lever engagement portion 137B of the rear door interlocking lever 137 and the engaged portion 38B of the fixing interlocking lever 38 are engaged only in the CW direction in FIG. 30A. Accordingly, as illustrated in FIGS. 30A and 30B, by an operation performed by the user, the rear door interlocking lever 137 can rotate until the rotation stop portion 137D of the rear door interlocking lever 137 butts the butted portion 125B of the fixing left cover 125. In the state illustrated in FIG. 30B, the hook portion 137E of the rear door interlocking lever 137 is hooked on the holding portion 125C of the fixing left cover 125. With this configuration, the rear door interlocking lever 137 can maintain the state illustrated in FIG. 30B.

In the present exemplary embodiment, when the rear door interlocking lever 137 moves and butts the fixing left cover 125 after the separation from the latch 41, the orientation of the rear door interlocking lever 137 is maintained by the hook portion 137E provided on the rear door interlocking lever 137, and the holding portion 125C of the fixing left cover 125. With this configuration, when the state is the state illustrated in FIG. 30B, even in a case where the weight of the rear door interlocking lever 137 generates rotational force for rotating the lever in the CCW direction in FIGS. 30A and 30B, the orientation of the rear door interlocking lever 137 can be maintained.

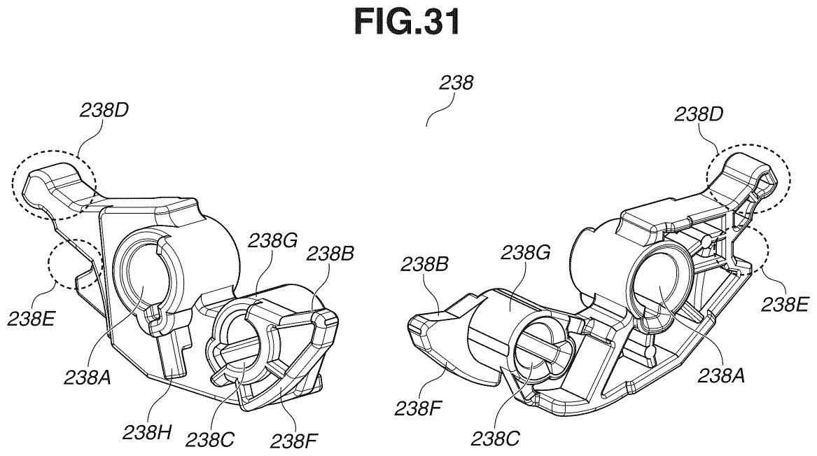

Next, a third exemplary embodiment of the present disclosure will be described with reference to FIGS. 31 to 33A and 33B. In the third exemplary embodiment, the description of components similar those in the first exemplary embodiment is omitted. A difference from the first exemplary embodiment lies in a configuration related to the movement of a rear door interlocking lever after a latch and the rear door interlocking lever are separated.

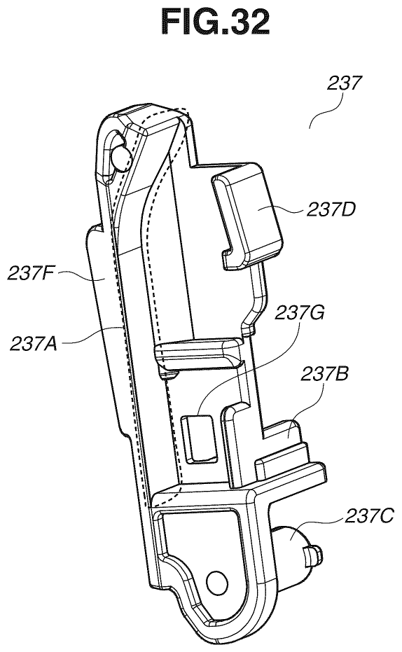

FIG. 31 is a diagram illustrating the shape of a fixing interlocking lever, and FIG. 32 is a diagram illustrating the shape of a rear door interlocking lever. In FIG. 31, a fixing interlocking lever 238 includes a first rotational center hole 238A of approximately circular shape to be fitted with the cover rotation central shaft 25A of the fixing left cover 25, an engaged portion 238B for interlocking with a rear door interlocking lever 237 when the rear door 20 is opened, a second rotational center hole 238C of approximately circular shape for rotatably supporting the rear door interlocking lever 237, and a first engagement portion 238D and a second engagement portion 238E for interlocking the opening and closing of the rear door 20 with the pressure release cam 36. The fixing interlocking lever 238 also includes a pressed portion 238F for rotating the fixing interlocking lever 238 by being pressed from the rear door guide 44 when the rear door 20 is closed. The fixing interlocking lever 238 further includes a cylindrical portion 238G holding a coil portion of a rear door interlocking lever spring (first biasing member) 244, a fixed arm regulation portion 238H that regulates a fixed arm 244B of the rear door interlocking lever spring 244, a fixing first side panel 221, and a butting portion 238J.

In FIG. 32, the rear door interlocking lever 237 includes a first lever engagement portion 237A for interlocking with the rear door 20 when the rear door 20 is opened, a second lever engagement portion 237B for interlocking an opening operation of the rear door 20 with the fixing interlocking lever 238, a rotation central shaft 237C of approximately circular shape to be fitted with the second rotational center hole 238C of the fixing interlocking lever 238, and a rotation stop portion 237D for stopping rotation by butting the butted portion 25B of the fixing left cover 25. The rear door interlocking lever 237 also includes a surface 237F for retracting the latch 41 that comes into contact with the latch 41 when the rear door 20 is closed. The rear door interlocking lever 237 further includes a spring engagement portion 237G for engaging with an actuation arm 244A of the rear door interlocking lever spring 244.

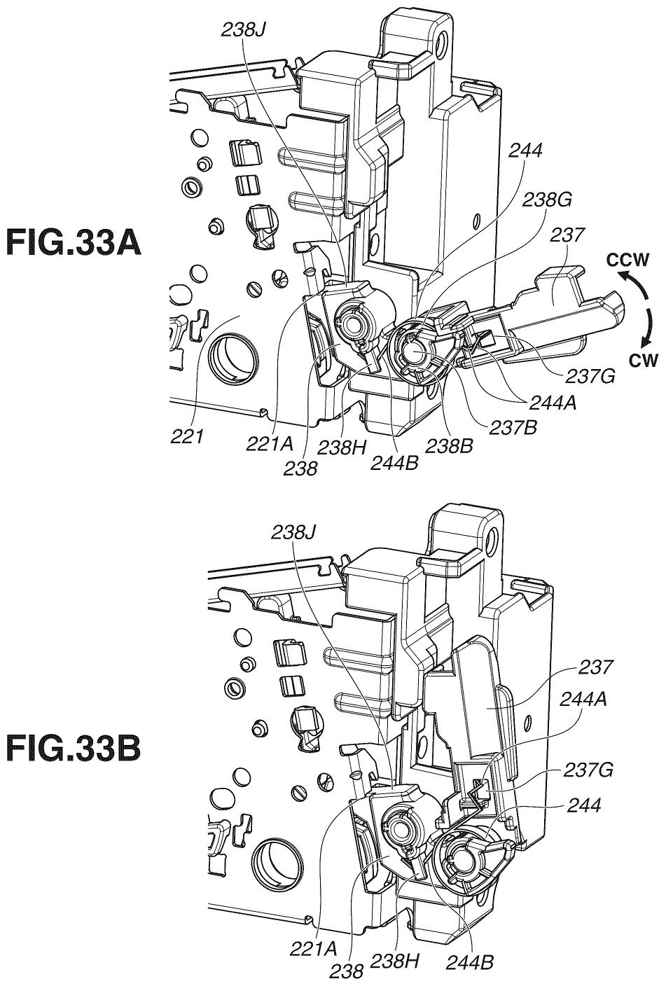

FIGS. 33A and 33B are diagrams illustrating a configuration of movement of the rear door interlocking lever 237 after the latch 41 and the rear door interlocking lever 237 are separated from each other. After the rear door interlocking lever 237 is separated from the latch 41, the second lever engagement portion 237B of the rear door interlocking lever 237 and the engaged portion 238B of the fixing interlocking lever 238 are engaged only in the CW direction. The fixing device 9 also includes the rear door interlocking lever spring 244. The coil portion of the rear door interlocking lever spring 244 is held by the cylindrical portion 238G of the fixing interlocking lever 238. The fixed arm 244B of the rear door interlocking lever spring 244 is fixed to the fixed arm regulation portion 238H of the fixing interlocking lever 238, and the actuation arm 244A is engaged with the spring engagement portion 237G of the rear door interlocking lever 237. In this state, rotational force for rotating the rear door interlocking lever 237 in the CCW direction in FIG. 33A is applied to the rear door interlocking lever 237 by the actuation arm 244A of the rear door interlocking lever spring 244. Here, rotational force for rotating in the CW direction is applied also to the fixing interlocking lever 238 by the fixed arm 244B of the rear door interlocking lever spring 244, but the fixing interlocking lever 238 does not rotate because the butting portion 238J butts a lever contact portion 221A of the fixing first side panel 221. Accordingly, only the rear door interlocking lever 237 rotates, the rear door interlocking lever 237 enters the state illustrated in FIG. 33B, from the state illustrated in FIG. 33A, and the state illustrated in FIG. 33B is maintained.

In the present exemplary embodiment, after the rear door interlocking lever 237 is separated from the latch 41, the rear door interlocking lever 237 moves by the rotational force of the rear door interlocking lever spring 244. Accordingly, after the rear door interlocking lever 237 is separated from the latch 41, the rear door interlocking lever 237 can move to the state illustrated in FIG. 33B, without an operation being performed by the user or the like. With this configuration, usability improves as compared with the first and second exemplary embodiments.

Exemplary embodiments of the present disclosure have been specifically described above, but the disclosure is not limited to the above-described exemplary embodiments, and various modifications can be made based on the technical idea of the disclosure.

### Additional Statement

The disclosure of the present exemplary embodiment includes the following configuration examples and method examples.

### (Item 1)

An image forming apparatus including:

an apparatus main body;
a door provided to be openable and closable with respect to the apparatus main body;
a fixing unit that is configured to fix a toner image formed on a sheet to the sheet, and includes a pressing member, a pressed member configured to form a fixing nip portion with the pressing member, and a pressing force adjustment unit for reducing or releasing pressing force to be applied to the fixing nip portion; and
an interlocking unit that is engageable with the pressing force adjustment unit, and configured to interlock opening and closing of the door with the pressing force adjustment unit, wherein the door includes a door engagement portion configured to engage with the interlocking unit,
wherein the interlocking unit includes a first interlocking member and a second interlocking member that are engaged with each other,
wherein the fixing unit is switchable between a first state that is a state where predetermined pressing force is applied to the fixing nip portion, and is caused when the pressing force adjustment unit is at a first position, and a second state that is a state where pressing force to be applied to the fixing nip portion is reduced from the predetermined pressing force or released, and is caused when the pressing force adjustment unit is at a second position,
wherein, during a process of opening the door from a closed state, the door engagement portion and the second interlocking member are engaged, the first interlocking member and the pressing force adjustment unit are engaged, and by the first interlocking member moving the pressing force adjustment unit, the pressing force adjustment unit moves from the first position to the second position,
wherein, during a process of opening the door, when the pressing force adjustment unit is at the second position, the second interlocking member gets separated from the door engagement portion, and the second interlocking member is movable with respect to the first interlocking member when the pressing force adjustment unit is in the second state, and
wherein, during a process of closing the door, by moving the first interlocking member, the first interlocking member moves the pressing force adjustment unit to the first position irrespective of a motion of the second interlocking member.

### (Item 2)

The image forming apparatus according to item 1, wherein, by the door pressing the first interlocking member during the process of closing the door, the first interlocking member is moved, and the first interlocking member moves the pressing force adjustment unit to the first position.

### (Item 3)

The image forming apparatus according to item 1 or 2,

wherein the fixing unit includes a pressing plate for applying pressing force to the fixing nip portion,
wherein the pressing force adjustment unit includes a cam member engageable with the first interlocking member, and a moving member configured to come into contact with the cam member and the pressing plate, and
wherein, when the first interlocking member and the cam member are engaged, the cam member rotates in tandem with the first interlocking member, the cam member comes into contact with the moving member, the moving member comes into contact with the pressing plate, and a position of the pressing plate changes, whereby the fixing unit switches between the first state and the second state.

### (Item 4)

The image forming apparatus according to items 1 to 3,

wherein the first interlocking member includes a first engagement portion and a second engagement portion,
wherein the cam member includes a first engaged portion,
wherein the second interlocking member includes a second engaged portion and a third engagement portion,
wherein, when the door is opened, the third engagement portion and the door engagement portion are engaged, the second engagement portion and the second engaged portion are engaged, the first engagement portion and the first engaged portion are engaged, the door engagement portion moves, and the cam member rotates, whereby the fixing unit switches from the first state to the second state, and
wherein, when the fixing unit is in the second state, the third engagement portion and the door engagement portion are separated from each other.

### (Item 5)

The image forming apparatus according to items 1 to 4,

wherein, by the first interlocking member and the second interlocking member rotating in tandem with an opening operation of the door, the pressing force adjustment unit moves from the first position to the second position,
wherein the first engagement portion and the first engaged portion are engaged when rotating in whichever direction of a first rotational direction in which the first interlocking member and the second interlocking member rotate when the pressing force adjustment unit moves from the first position to the second position, and a second rotational direction, which is an opposite direction to the first rotational direction,
wherein, in a case where the second interlocking member rotates in the first rotational direction, the second engagement portion and the second engaged portion are engaged,
wherein, in a case where the second interlocking member rotates in the second rotational direction, the second engagement portion and the second engaged portion are not engaged, and
wherein, after the third engagement portion and the door engagement portion are separated from each other in tandem with an opening operation of the door, the second interlocking member is rotatable in the second rotational direction without moving the pressing force adjustment unit.

### (Item 6)

The image forming apparatus according to items 1 to 5,

wherein the fixing unit includes a cover member,
wherein the second interlocking member includes a butting portion,
wherein the cover member includes a butted portion,
wherein, after the third engagement portion and the door engagement portion are separated from each other in tandem with opening of the door, the second interlocking member rotates in the second rotational direction until the butting portion butts the butted portion, and
wherein, after the butting portion butts the butted portion, orientation of the second interlocking member is maintained in a state where the butting portion butts the butted portion by its own weight.

### (Item 7)

The image forming apparatus according to items 1 to 6,

wherein the fixing unit includes a cover member,
wherein the second interlocking member includes a butting portion and a hook portion,
wherein the cover member includes a butted portion and a holding portion,
wherein, after the third engagement portion and the door engagement portion are separated from each other in tandem with opening of the door, the second interlocking member rotates in the second rotational direction until the butting portion butts the butted portion, and
wherein, by the second interlocking member entering a state where the hook portion is hooked on the holding portion, in a state where the butting portion butts the butted portion, orientation is maintained.

### (Item 8)

The image forming apparatus according to items 1 to 7,

wherein the interlocking unit includes a first biasing member configured to bias the second interlocking member in the second rotational direction, and
wherein, after the third engagement portion and the door engagement portion are separated from each other in tandem with opening of the door, the second interlocking member rotates in the second rotational direction by biasing force of the first biasing member without moving the pressing force adjustment unit.

### (Item 9)

The image forming apparatus according to items 1 to 8,

wherein the door engagement portion includes an engagement member configured to engage with the third engagement portion, and
wherein the door includes a second biasing member configured to bias the engagement member in a direction in which the engagement member engages with the third engagement portion.

### (Item 10)

The image forming apparatus according to items 1 to 9,

wherein the door includes a pressing portion,
wherein the first interlocking member includes a pressed portion,
wherein the second interlocking member includes a contact portion,
wherein the engagement member includes a contacted portion,
wherein the pressing portion presses the pressed portion in tandem with a closing operation of the door, the cam member rotates by the first interlocking member rotating, and the pressing force adjustment unit switches from the second position to the first position, and
wherein the engagement member moves by the contacted portion coming into contact with the contact portion, and if the contacted portion and the contact portion are separated from each other by the door being further closed, the engagement member moves by being biased by the second biasing member in such a manner that the third engagement portion and the engagement member are engaged.

### (Item 11)

The image forming apparatus according to items 1 to 10,

wherein the pressing member is a pressing roller,
wherein the pressed member is a heating unit, and
wherein a sheet conveyed to the fixing nip portion formed by the pressing roller and the heating unit is conveyed by being nipped between the pressing roller and the heating unit, and heat and pressure are applied, whereby the toner image formed on the sheet is fixed.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2024-101546, filed Jun. 24, 2024, which is hereby incorporated by reference herein in its entirety.

What is claimed is:

1. An image forming apparatus comprising:
an apparatus main body;
a door provided to be openable and closable with respect to the apparatus main body;
a fixing unit that is configured to fix a toner image formed on a sheet to the sheet, and includes a pressing member, a pressed member configured to form a fixing nip portion with the pressing member, and a pressing force adjustment unit for reducing or releasing pressing force to be applied to the fixing nip portion; and
an interlocking unit that is engageable with the pressing force adjustment unit, and configured to interlock opening and closing of the door with the pressing force adjustment unit,
wherein the door includes a door engagement portion configured to engage with the interlocking unit,
wherein the interlocking unit includes a first interlocking member and a second interlocking member that are engaged with each other,
wherein the fixing unit is switchable between a first state that is a state where predetermined pressing force is applied to the fixing nip portion, and is caused when the pressing force adjustment unit is at a first position, and a second state that is a state where pressing force to be applied to the fixing nip portion is reduced from the predetermined pressing force or released, and is caused when the pressing force adjustment unit is at a second position,
wherein, during a process of opening the door from a closed state, the door engagement portion and the second interlocking member are engaged, the first interlocking member and the pressing force adjustment unit are engaged, and by the first interlocking member moving the pressing force adjustment unit, the pressing force adjustment unit moves from the first position to the second position,
wherein, during a process of opening the door, when the pressing force adjustment unit is at the second position, the second interlocking member gets separated from the door engagement portion, and the second interlocking member is movable with respect to the first interlocking member when the pressing force adjustment unit is in the second state, and
wherein, during a process of closing the door, by moving the first interlocking member, the first interlocking member moves the pressing force adjustment unit to the first position irrespective of a motion of the second interlocking member.

2. The image forming apparatus according to claim 1, wherein, by the door pressing the first interlocking member during the process of closing the door, the first interlocking member is moved, and the first interlocking member moves the pressing force adjustment unit to the first position.

3. The image forming apparatus according to claim 1,
wherein the fixing unit includes a pressing plate for applying pressing force to the fixing nip portion,
wherein the pressing force adjustment unit includes a cam member engageable with the first interlocking member, and a moving member configured to come into contact with the cam member and the pressing plate, and
wherein, when the first interlocking member and the cam member are engaged, the cam member rotates in tandem with the first interlocking member, the cam member comes into contact with the moving member, the moving member comes into contact with the pressing plate, and a position of the pressing plate changes, whereby the fixing unit switches between the first state and the second state.

4. The image forming apparatus according to claim 3,
wherein the first interlocking member includes a first engagement portion and a second engagement portion,
wherein the cam member includes a first engaged portion,
wherein the second interlocking member includes a second engaged portion and a third engagement portion,
wherein, when the door is opened, the third engagement portion and the door engagement portion are engaged, the second engagement portion and the second engaged portion are engaged, the first engagement portion and the first engaged portion are engaged, the door engagement portion moves, and the cam member rotates, whereby the fixing unit switches from the first state to the second state, and
wherein, when the fixing unit is in the second state, the third engagement portion and the door engagement portion are separated from each other.

5. The image forming apparatus according to claim 4,
wherein, by the first interlocking member and the second interlocking member rotating in tandem with an opening operation of the door, the pressing force adjustment unit moves from the first position to the second position,
wherein the first engagement portion and the first engaged portion are engaged when rotating in whichever direction of a first rotational direction in which the first interlocking member and the second interlocking member rotate when the pressing force adjustment unit moves from the first position to the second position, and a second rotational direction, which is an opposite direction to the first rotational direction,
wherein, in a case where the second interlocking member rotates in the first rotational direction, the second engagement portion and the second engaged portion are engaged,
wherein, in a case where the second interlocking member rotates in the second rotational direction, the second engagement portion and the second engaged portion are not engaged, and
wherein, after the third engagement portion and the door engagement portion are separated from each other in tandem with an opening operation of the door, the second interlocking member is rotatable in the second rotational direction without moving the pressing force adjustment unit.

6. The image forming apparatus according to claim 5,
wherein the fixing unit includes a cover member,
wherein the second interlocking member includes a butting portion,
wherein the cover member includes a butted portion,
wherein, after the third engagement portion and the door engagement portion are separated from each other in tandem with opening of the door, the second interlocking member rotates in the second rotational direction until the butting portion butts the butted portion, and
wherein, after the butting portion butts the butted portion, orientation of the second interlocking member is maintained in a state where the butting portion butts the butted portion by its own weight.

7. The image forming apparatus according to claim 5,
wherein the fixing unit includes a cover member,
wherein the second interlocking member includes a butting portion and a hook portion,
wherein the cover member includes a butted portion and a holding portion,
wherein, after the third engagement portion and the door engagement portion are separated from each other in tandem with opening of the door, the second interlocking member rotates in the second rotational direction until the butting portion butts the butted portion, and
wherein, by the second interlocking member entering a state where the hook portion is hooked on the holding portion, in a state where the butting portion butts the butted portion, orientation is maintained.

8. The image forming apparatus according to claim 5,
wherein the interlocking unit includes a first biasing member configured to bias the second interlocking member in the second rotational direction, and
wherein, after the third engagement portion and the door engagement portion are separated from each other in tandem with opening of the door, the second interlocking member rotates in the second rotational direction by biasing force of the first biasing member without moving the pressing force adjustment unit.

9. The image forming apparatus according to claim 4,
wherein the door engagement portion includes an engagement member configured to engage with the third engagement portion, and
wherein the door includes a second biasing member configured to bias the engagement member in a direction in which the engagement member engages with the third engagement portion.

10. The image forming apparatus according to claim 9,
wherein the door includes a pressing portion,
wherein the first interlocking member includes a pressed portion,
wherein the second interlocking member includes a contact portion,
wherein the engagement member includes a contacted portion,
wherein the pressing portion presses the pressed portion in tandem with a closing operation of the door, the cam member rotates by the first interlocking member rotating, and the pressing force adjustment unit switches from the second position to the first position, and
wherein the engagement member moves by the contacted portion coming into contact with the contact portion, and if the contacted portion and the contact portion are separated from each other by the door being further closed, the engagement member moves by being biased by the second biasing member in such a manner that the third engagement portion and the engagement member are engaged.

11. The image forming apparatus according to claim 1,
wherein the pressing member is a pressing roller,
wherein the pressed member is a heating unit, and
wherein a sheet conveyed to the fixing nip portion formed by the pressing roller and the heating unit is conveyed by being nipped between the pressing roller and the heating unit, and heat and pressure are applied, whereby the toner image formed on the sheet is fixed.
